(19) United States
(12) Patent Application Publication
(10) Pub. No.: US 2007/0264616 A1
(43) Pub. Date: Nov. 15, 2007

(54) Structure of Detecting Device Used in Miles System and Gun Simulator

(76) Inventor: Balentino Namgung, Gyeonggi-do (KR)

Correspondence Address: THE FARRELL LAW FIRM, P.C., 333 EARLE OVINGTON BOULEVARD, SUITE 701, UNIONDALE, NY, 11553, US

(21) Appl. No.: 10/582,843

(22) PCT Filed: Dec. 15, 2004
(86) PCT No.: PCT/KR04/03311

§ 371 Date: Apr. 3, 2007

(30) Foreign Application Priority Data
Dec. 15, 2003 (KR) 10-2003-0091035
Jan. 6, 2004 (KR) 10-2004-0000750

(51) Int. Cl. F41A 33/00; G01J 1/44

(52) U.S. Cl. 434/16; 250/206

(57) ABSTRACT

Disclosed is a detecting device for hit determination by detecting a light shot from a transmitter. The detecting device according to the invention comprises a plurality of detecting elements. Each detecting element includes an optical detector cell of a planar shape for generating an electric signal when detecting a light, a protection case of a cylindrical shape for supporting the optical detector cell housed inside thereof, a set of lead wires, each of which being electrically connected to an anode electrode and a cathode electrode of the optical detector cell for supplying the electric signal generated from the optical detector cell to hit determination means, and a protection shield located on a front light detecting surface of the optical detector cell for protecting the optical detector cell from external environment and passing the light. The protection case of a cylindrical shape has an open front surface. The optical detector cell of a planar shape has a light detecting front surface adjacent to the open front surface of the protection case, and a rear surface supported by a packing material packed inside of the protection case. The set of lead wires is elongated from the rear surface of the optical detector cell and protected by the packing material.

### TECHNICAL FIELD

The present invention relates to a detecting device used in a MILE system (multiple integrated laser engagement system, hereinafter ‘MILES’) and a gun simulation system, and in particular, to a target detecting device of a MILES using a laser light and to a housing of a magazine shape or a simulated magazine used in an arms transmitter as well as to a gun simulation system related thereto.

### BACKGROUND ART

During the last several years, military armies have performed training for simulated combat, which is similar to a real combat, by introducing a multiple integrated laser engagement system MILES comprising a small arms transmitter (SAT) for shooting laser light, instead of bullets, which is mounted to small guns or other kinds of arms transmitter, and an optical detector for detecting hit of a target by sensing the laser light.

The conventional detecting element comprises an optical detector cell for converting the detected laser light into electric signals; a protection case for protecting the optical detector cell from external strong impact; lead wires connected to an electrode of the optical detector for transmitting the electric signals generated from the optical detector cell to a sensor MPU (Microprocessor Unit), which determines hit of a target; a filtering window for filtering light of wavelengths different from the shot laser light as noise and protecting the elements from external environment; and a resin molding layer mounted on a lower portion of the filtering window for protecting the lead wires by means of sealing.

Despite its superior characteristics, the conventional detecting element with the above structure has a narrow optical sight angle (α) incapable of receiving light due to an attachment of its optical detector cell to the bottom of its protection case and a resultant narrow detection scope of the detecting elements. Such problems heighten the probability of erroneously determining that the laser light has missed a target if the laser light hits a side surface of the detecting element or the space between the detecting elements. Such probability is different from the actual probability that is likely to occur in a real combat.

The only available measure to prevent the errors is to narrow the space between the detecting elements. However, this measure is not so efficient in terms of cost and management as it requires more detecting elements per soldier or target.

Another problem of the conventional detecting element lies in increase of its entire volume, particularly of its thickness (h), because the optical detector cell and the protection case need to be wrapped by an external skin comprising a filtering window. When performing military training in the field with the conventional detecting elements of thick and protruded shape on their chests or backs that would become in contact with solid ground in case of crawling or ambushing, the soldiers suffering from the pressure of the protruded detecting elements are liable to act differently from the real combat to avoid the pressure. This eventually reduces the effect of training.

Another problem of the conventional detecting element lies in its surface, which is a filtering window composed of polycarbonate that is vulnerable to strong impact and frequently malfunctions when soldiers perform severe acts of falling, crawling, ambushing or clashing. The vacant space between the surface and the internal element fails to protect the thin surface from external import or heavy weight.

Still another problem of the conventional detecting element is that the lead wires on the lower portion thereof are highly likely to be twisted or broken. In FIG. 2, each detecting element is connected to an adjacent detecting element with the same electrode through a single lead wire connection point. As a result, the lead wires become complicatedly twisted as shown in FIG. 2. When the military training is performed in the field under such state, the lead wires can be easily broken. If any lead wire of a soldier's detecting device is broken and malfunctions in the course of training, the soldier will not be considered to have been shot by the laser light even if so. As a result, the overall training effective is reduced, and simulation of the real combat cannot be realized as desired by the MILES.

In short, the conventional detecting device having the above problems causes user inconvenience and reduces preciseness of the shooting, thereby reducing the effect of simulated combat training. Furthermore, immediate and partial repair of the detecting device is unavailable even if the detecting device malfunctions or is damaged. This results in inefficient management of the military equipment and increase of maintenance and repair costs. All in all, anticipation for the effect of scientific combat training becomes offset.

Meanwhile, the conventional MILES generally uses a method of shooting a light bullet, i.e., a laser light, by inserting a blank cartridge into a magazine of an arms transmitter and percussing the blank cartridge so that a sensor in the arms transmitter can sense the impact sound generated at the time of percussion. Accordingly, all the manipulation process of shooting a blank cartridge is the same as shooting a real bullet.

Despite its simplicity and accuracy, however, this manner of shooting a blank cartridge poses a problem of incurring a high cost for consuming a great number of blank cartridges in case of a military training of company or battalion scale.

By contrast, the manner of directly shooting a laser light by pushing a switch button protruded on a side surface of a transmitter, which is mounted on the gunbarrel, has an advantage of dispensing with a blank cartridge. However, this manner also poses a problem of being different from the actual act of pulling a trigger, and is unhelpful for training of aiming and shooting. Since it is impossible to separately perform trainings for single firing and quick firing, such simulation of being different from the real situation eventually deteriorates the training effect.

### DISCLOSURE OF INVENTION

To solve the above problems, it is an object of the present invention to provide a structure of a detecting device in a MILES having a broad sight angle.

It is another object of the present invention to provide a structure of a detecting device with high durability suitable for field training.

It is still another object of the present invention to provide a structure of a detecting device that can be easily repaired.

It is still another object of the present invention to provide a structure of the MILES carrying an effect similar to the situation of shooting real bullets without blank cartridges.

It is still another object of the present invention to provide a structure of the MILES capable of simulating shooting modes such as automatic, semi-automatic and locked shooting modes while shooting laser light by pulling a trigger with the same manner as in case of shooting real bullets.

It is still another object of the present invention to provide a structure of the MILES capable of simulating a shooting sound, a shooting impact or a shooting light when shooting a laser light.

It is still another object of the present invention to provide a housing or a structure of a simulated magazine identical or similar to a real magazine in its external shape while housing electrical and mechanical modules inside thereof so as to carry the above effects.

It is still another object of the present invention to provide a structure of a simulated magazine capable of performing the function of a wireless installation or a walkie-talkie.

It is still another object of the present invention to provide a structure of a gun simulation system capable of shooting laser light by pulling a trigger without a simulated magazine.

In carrying out the invention and according to one aspect thereof, there is provided a detecting element used in a MILES, comprising: an optical detector cell of a planar shape for generating an electric signal when detecting a light; a protection case of a cylindrical shape for supporting the optical detector cell housed inside thereof; a set of lead wires, each of which is electrically connected to an anode electrode and a cathode electrode of the optical detector cell for supplying the electric signal generated from the optical detector cell to hit determination means; and a protection shield located on a front light detecting surface of the optical detector cell for protecting the same from external environment and shielding noise light at the same time. Here, the protection case of a cylindrical shape is characterized by an open front surface, while the optical detector cell of a planar shape is characterized by a front surface, which is located to be adjacent to the open front surface of the protection case so as to detect the light, as well as by a rear surface supported by a packing material packed inside of the protection case. The set of lead wires is elongated from the rear surface of the optical detector cell and protected by the packing material

According to another aspect of the invention, there is provided a structure of a transmitter or a gun simulation system, comprising: percussion signal generation means for generating a percussion signal when a trigger of a gun is pulled; percussion signal output means for outputting the generated percussion signal; a housing of a magazine shape, an upper tip of which is inserted and fixed into a magazine insertion section of the gun; and a laser light transmitter mounted on the gun for shooting a laser light to hit a target. Here, the housing comprises: percussion signal input means for receiving the percussion signal outputted from the percussion signal output means; shooting mode designation means for designating a shooting mode of the laser light transmitter; a microcomputer for generating a responsive shooting signal upon recognition of a shooting mode designated by the shooting mode designation means after receiving the shooting signal from the percussion signal input means; and shooting signal output means for supplying the shooting signal generated from the microcomputer to the laser light transmitter. Here, the laser light transmitter includes shooting signal input means for receiving the shooting signal outputted from the shooting signal output means, and shooting the laser light by inputting the shooting signal. The laser light transmitter is used in a MILES or in a survival game, which simulates that a target is hit if the shot laser light arrives at the detecting element mounted on the target.

The detecting element according to the invention can be used for hit determination of a soldier by being spaciously mounted around the chest, belly, back and/or head of the soldier or on the surface of a vehicle, warship or a combat plane.

In the detecting device according to the invention, the optical detector cell is located to be adjacent to a surface of the detecting element, thereby drastically widening the sight angle. Therefore, the detecting device according to the invention serves to enhance the training efficiency by heightening accuracy of hit determination and to reduce the cost for acquisition and management of the military equipment as the detection can cover a wide range zone with a small number of detecting elements.

The detecting element according to the invention has a structure suitable to a field environment owing to its notably improved durability compared to the conventional detecting element because the rear surface of the optical detector cell is supported by the hardened resin, etc., while the front surface thereof is shielded by a solid protection shield.

Moreover, the protection shield includes conductive mesh inside thereof, thereby serving to filter electromagnetic noise and to enhance its mechanical strength.

The detecting element according to the invention is notably thin, and thus eliminates the user inconvenience even when performing the crawling or ambushing training.

In the detecting element according to the invention, the protection shield is easily attachable and detachable from the surface of the optical detector cell so that the surface can be easily and promptly repaired and reused when damaged.

The detecting element according to the invention also reduced the probability of twisting or breaking of the lead wires, thereby enhancing durability of the equipment.

In the detecting element according to the invention, a protrusion protection section protruded around a periphery of the protection case prevents the inner devices from being easily damaged even when clashed with a solid surface.

The detecting device according to the invention is structured to comprehensively systemize and simplify the process of manufacture and assembly, thereby reducing the production cost.

The detecting device according to the invention further comprises means to generate an amplifying or original ID for each detecting element so as to simulate situations such as light injury, heavy injury, death or half-destruction or entire destruction, etc. in addition to determining a simple hit or near-missing state. The detecting device according to the invention can further determine a particular hit area, and subsequently, the training can be performed in more precise and realistic manners.

Meanwhile, the simulated magazine in the present invention eliminates the necessity of using any roaring explosives, blank cartridges or light tracers of high cost, unlike the conventional art, by transmitting the percussion signal generated from a trigger to a laser light transmitter.

The simulated magazine in the present invention is structured not to be shot with a single light through generation of a single trigger or a percussion signal but to perform the semi-automatic, automatic or locked shooting modes in accordance with a preset shooting mode. The simulated magazine in the present invention also comprises the devices of demonstrating a shooting sound, a shooting impact or a shooting light so as to dispense with any blank cartridges in simulating a real shooting situation.

Moreover, the speaker mounted on the simulated magazine in the present invention can substitute wireless installations, thereby maximizing the efficiency of handling the equipment.

Finally, the present invention improved the problems in the conventional unrealistic MILES of shooting a laser light by pushing a switch mounted on a side surface of an arms transmitter by enabling the laser light to be shot from a light transmitter mounted on a gunbarrel when a trigger of arms is pulled without any simulated magazine.

### BRIEF DESCRIPTION OF THE DRAWINGS

The above object, features and advantages of the present invention will become more apparent from the following detailed description when taken in conjunction with the accompanying drawings, in which:

FIG. 1 is a schematic diagram of a MILES;

FIG. 2 is a perspective view of the conventional detecting element used in the MILES;

FIG. 3 is a cross-sectional view of FIG. 2;

FIG. 4 is a cross-sectional view of a detecting element according to a best mode of the present invention;

FIG. 5 is a schematic diagram illustrating a process of completing a detecting device through connection of a plurality of detecting elements to a module section for processing signals with a set of lead wires according to a best mode of the present invention;

FIG. 6 is a cross-sectional view of the detecting element according to another best mode of the present invention;

FIG. 7 is a cross-sectional view of the detecting element according to another best mode of the present invention;

FIG. 8 is a cross-sectional view of the detecting element according to another mode of the present invention;

FIG. 9 is a cross-sectional view of the detecting element according to another mode of the present invention;

FIG. 10 is a perspective view of FIG. 9 illustrating lead wires drawn from side surfaces of the detecting element;

FIG. 11 is a cross-sectional view of the detecting element according to another mode of the present invention;

FIG. 12 is a perspective view of FIG. 1;

FIG. 13 is a cross-sectional view of the detecting element according to another mode of the present invention;

FIG. 14 is a cross-sectional view of the detecting element according to another mode of the present invention;

FIG. 15 is a cross-sectional view of the detecting element according to another mode of the present invention;

FIG. 16 is a cross-sectional view of the detecting element according to another mode of the present invention;

FIG. 17 is a schematic diagram illustrating a method of distributing lead wires according to the present invention;

FIG. 18 is a schematic diagram illustrating electric connections of a plurality of detecting elements distributed according to the present invention;

FIG. 19 is a block diagram of a detecting device according to the present invention;

FIG. 20 is a cross-sectional view of the detecting element according to another mode of the present invention;

FIG. 21 is a top-plan view of M16 type individual firearms illustrating a gun simulation system according to the present invention;

FIG. 22 is a schematic diagram of a percussion signal generation device of a wire type according to a best mode of the present invention;

FIG. 23 is a schematic diagram of a percussion signal generation device of a wire type according to another mode of the present invention;

FIG. 24 is a schematic diagram of a percussion signal generation device of a wire type according to another mode of the present invention;

FIG. 25 is a schematic diagram of a percussion signal generation device of a wireless type according to another mode of the present invention;

FIG. 26 is a schematic diagram illustrating an internal structure of a simulated magazine according to the present invention;

FIG. 27 is a graph illustrating percussion signals and corresponding shooting signals;

FIG. 28 is a schematic diagram illustrating a structure of a laser light transmitter according to the present invention;

FIG. 29 is a block diagram illustrating a simulated magazine according to another mode of the present invention;

FIG. 30 is a schematic diagram illustrating a mechanical structure of FIG. 29;

FIG. 31 is a top-plan view of M-16 type individual firearms illustrating a gun simulation system without the simulated magazine according to another mode of the present invention;

FIG. 32 is a schematic diagram illustrating a mechanical structure of FIG. 31;

FIG. 33 is a top-plan view of M-16 type individual firearms illustrating a gun simulation system without the simulated magazine according to another mode of the present invention; and

FIG. 34 is a schematic diagram illustrating a mechanical structure of FIG. 33.

### BEST MODES FOR CARRYING OUT THE INVENTION

Best modes for carrying out the present invention will now be described with reference to the accompanying drawings. The matters defined in the description are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

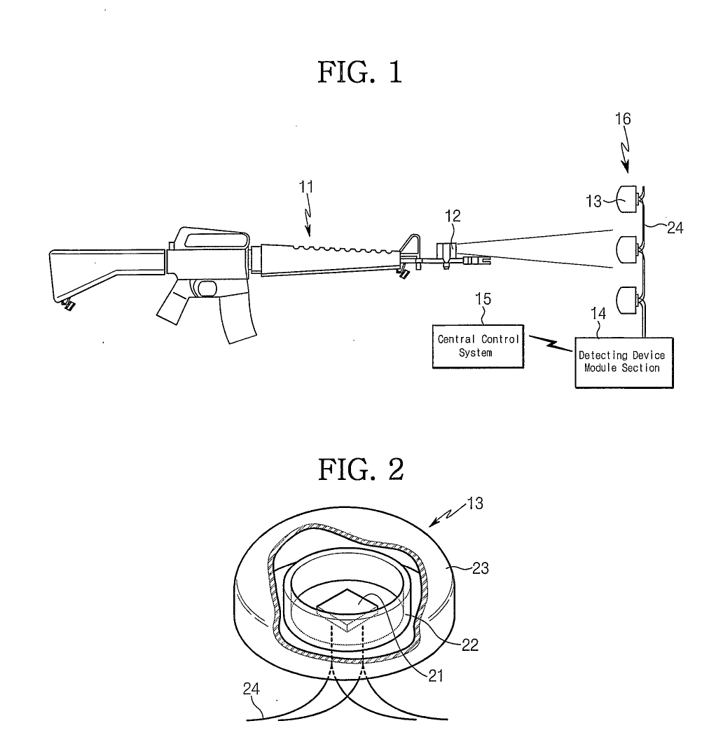

FIG. 1 is a schematic diagram of a MILES. The MILES as shown in FIG. 1 is operated in the following manner.

If a soldier pulls a trigger of individual or public firearms 11 after aiming a target, a blank cartridge, etc. is shot from the firearms 11. At this stage, an acoustic sensor or an optical sensor inside of a SAT 12 senses the sound or light generated at that time and activates an infrared layer laser diode mounted on the SAT 12. Then, the infrared layer laser of a pulse type is shot toward the aimed target. If the shot laser hits any one of the detecting elements 13 of a detecting device 16, which is mounted outside of the target, such as a helmet or a harness surrounding the soldier or an armored motorcar, etc., a laser signal inputted to the shot detecting element is converted into an electric signal and transmitted to a microprocessor section housed in a module section 14 of the detecting device (hereinafter, referred to as the “detecting device MPU”). The detecting device MPU recognizing this signal as a hit signal indicates the hit in visual and aural manners by means of a warning light attached to the soldier's body in accordance with a predetermined logic. At the same time, the detecting device MPU may suspend operation of the SAT 12, which is the arms transmitter of the corresponding soldier. Further, the detecting device MPU can also transmit the hit signal to a central control system 15, which is remotely located, by means of a communication module in the module section 14 of the detecting device so that the central control system 15 can control the hit. Hereinafter, the individual optical detector modules will be referred to as the detecting element 13 so as to be distinguished from the detecting device 16, which comprises such detecting elements and the module section 14 as a unit attached to a single target.

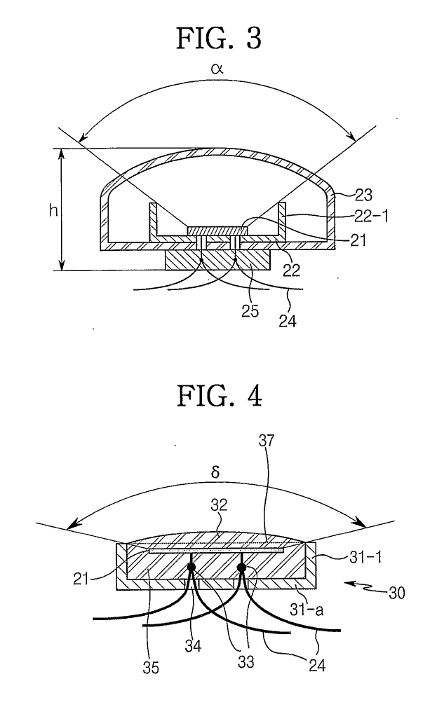

FIG. 2 is a perspective view and FIG. 3 is a cross-sectional view illustrating internal structures of the conventional detecting element used in the MILES.

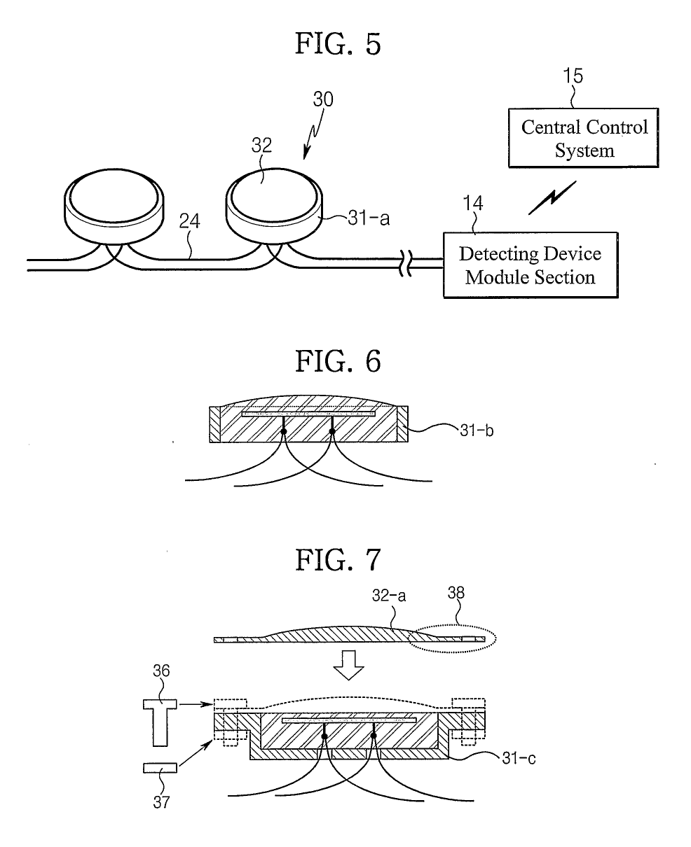

FIG. 4 is a cross-sectional view of a detecting element 30, and FIG. 5 is a schematic diagram illustrating a process of completing a detecting device through connection of a plurality of detecting elements 30 to a module section 14 for processing signals with a set of lead wires 24.

Each detecting element 30 comprises: an optical detector cell 21 for generating an electric signal upon receipt of an infrared layer laser light; a protection case 31-a of a cylindrical, rectangular or a predetermined shape housing the optical detector cell inside thereof; an anode electrode and a cathode electrode for concentrating electric charge generated from the optical detector cell 21 (neither of the electrodes are shown in the drawings); a plurality of lead wires 24 respectively connected to one another at a contact point 33 to transmit the electric signal generated from the optical detector cell 21 to the module section 14 of the detecting device that will be described later; and a protection case 32 for protecting the optical detector cell from external mechanical impact or moisture by covering a front light detecting surface of the optical detector cell, and performing optical filtering by passing the incident light within a predetermined band of wavelength and absorbing or reflecting other incident light beyond the predetermined band of wavelength.

According to the same principle as a solar battery, the optical detector cell 21 separates the incident light into electronics and micropyles so as to be converted into electric signals. The optical detector cell 21 comprises either a plurality of avalanche photo diodes (APD) or PIN photo diodes (PIN-PD), or of a single device having a high capacity of receiving light. Each diode is connected to an anode and a cathode for drawing the generated electric signals such as electric current or voltage. The anode and cathode constitute the contact point 33 together with the lead wires 24 on a rear surface of the optical detector cell 21. The lead wires 24 are drawn to lead wire holes 34 on a bottom surface of the protection case 31-a so as to be connected to the adjacent detecting elements. Hereinafter, the plurality of lead wires will be referred to as a set of lead wires.

In the present invention, the description will be based on public firearms such as individual firearms or machine guns for infantry equipped with semiconductor laser of GaAs series emitting laser within the wavelength range of 980 nm±30 nm or 900 nm±30 nm as a transmitter laser. However, it is out of question that the detecting element according to the present invention can be used by merely changing the type of the optical detector cell or the protection shield, which is an optical filter, even in case of employing the laser of high output within the wavelength range of 1,100 nm˜1,600 nm, which is available for simulating wide-range targets or long-range firearms such as recoilless rifles, electronic cannon, antitank firearms, grenade launcher, etc. or the light emitting diode (LED) within the wavelength range of 400 nm˜870 nm, which is available for spreading the light within the short range such as simulated mine, simulated hand grenade as a light source of the transmitter. In addition, the detecting element according to the present invention can also be used for the MILES to simulate direct-firing high-angle firearms, anti-aircraft firearms such as Balkan cannons, long-range high-angle firearms, cannons of naval vessels, heavy machine guns of combat planes, short-range missiles, etc. Therefore, the detecting element according to the present invention is neither limited to the MILES using individual firearms of the army nor limited to the case of employing infrared layer laser or laser for the light source of a transmitter.

One of the most outstanding features of the present invention is that the optical detector cell 21 is placed on the open front surface of the protection case 31-a, i.e., the front surface where the protection case 32 is installed so as to be of almost the same height as the side wall 3101 of the protection case 32. Such placement is in contrast to the conventional placement of the optical detector cell 21 at the bottom of the protection case 22 as shown in FIG. 3. Also being different in the conventional art is that a rear surface packing material 35 composed of hardened resin is packed inside of the protection case while supporting the rear surface of the optical detector cell 21.

The above construction serves to improve sensitivity of the detecting element and cover a relatively wider zone even with a small number of detecting elements by widening the sight angle, which is one of the biggest problems of the conventional art, to be δ. Also, the best mode of the present invention in FIG. 4 shows an internal structure with notably enhanced mechanical strength of the detecting element 30 firmly supported by the hardened rear surface packing material 35 unlike the conventional structure.

The sight angle becomes wider as the optical detector cell is located near the front surface of the protection case. When located higher than the side wall 31-1 of the protection case, however, the optical detector cell becomes vulnerable to mechanical impact. Hence, the upper limit should be on a par with the height of the side wall.

The protection case 31-a is generally composed of solid material so as to protect the optical detector cell from external impact. To prevent noise generated due to reflection, lusterless process may be performed on the protection case. The bottom surface of the protection case might become unnecessary if the rear surface packing material 35 supporting the rear surface of the optical detector cell, which will be described later, is firmly packed inside of the protection case and sufficiently hardened to mechanically protect the inner optical detector cell and the contact point, etc. In other words, the protection case 31-b without a bottom surface can also be available as shown in FIG. 6.

A protection shield 32 for protecting the front surface and filtering noise light other than the necessary light through absorption or reflection is mounted on the front light detecting surface of the optical detector cell. The noise light refers to all kinds of light other than the light shot from the transmitter that might interrupt hit determination as a noise. The protection shield may by mounted on the optical detector cell 21 independently from the rear surface packing material 35, or may surround the optical detector cell 21 to support the same as a single body, which is chemically integrated from the protection shield 32 with the rear surface packing material 35 by locating and hardening the optical detector cell 21 near the surface inside of the packing material after packing the whole inside of the protection case with a packing material such as resin at the beginning.

In case that the protection shield 32 is mounted on the optical detector cell 21 independently from the rear surface packing material 35, an interface 37 between the two may be adhered by means of transparent epoxy, or the protection shield 32 may be attachably/detachably mounted so as to be easily substituted when scarred or damaged. FIG. 7 shows an attachable/detachable protection shield 32-a that can be assembled by means of screws or rivets 36, 37 according to a best mode of the present invention. The periphery 38 of the protection shield 32-a may be thicker than shown in FIG. 7 so as to prevent the connected portion from being easily broken.

The protection shield 32 should not only have a mechanical strength but also should shield the incidence of light other than the light shot from the transmitter into the optical detector cell. The specifically problematic light is the zone of visible light layer and ultraviolet light layer emitted from the sun with the wavelength ranges being less than 800 nm. Thus, if the infrared layer laser is employed as a light source of the transmitter, the protection shield 32 or 32-a may be used with epoxy resin, which is composed of about 60% of bis-phenol A or polyether polyol by weight as a main material and Cu-phthalogreen for filtering of visible light as well as other hardening materials. However, the protection shield may also be formed with inorganic materials such as tempered glass with high mechanical strength and additionally having filtering means.

The detecting device according to the present invention may also be used in case of employing a transmitter for shooting the light belonging to the wavelength range of visible light layer or ultraviolet layer unlike the aforementioned best modes of the present invention. When simulating an explosion widely spread around a particular zone such as simulated hand grenade or simulated claymore, for example, it is more efficient to use the LED than the straightly driving laser as the light source for the simulated hand grenade, etc. In that case, however, the protection shield 32 should not simply function to filter the light of such wavelength range since the light from the emitting diode might fall within the same range as the sunlight.

The detecting element used in that case may have a protection shield of greater thickness so that the light emitted with greater intensity from a transmitter than from the sunlight can only be incident to the optical detector cell by increasing the filtered quantity of light. Otherwise, it is also possible to scan components of the sunlight or noise light in advance of the military training, and store the converted electric signal values in the MPU of the detecting device and/or logic of the central control system. A hit can then be precisely determined by deducting the stored noise value from the value detected by the optical detector cell in the course of military training. Thus, the protection shield according to the present invention does not merely refer to a shield performing the function of reflecting, absorbing or passing the light based on the wavelength alone. Also, the meaning of “shielding the noise light” according to the present invention is not limited to merely passing the noise light but includes eliminating the passed light when a hit has been determined by means of a program logic.

The protection shield according to the present invention may be of convex shape, as shown in the drawings, or of planar or another shape.

In general, the rear surface packing material 35 for supporting the rear surface of the optical detector cell may be mainly composed of bis-phenol A or polyether polyol. To enhance mechanical strength and adhesivity, acid anhydride, silica, etc. may be added thereto. It is out of question that dye material or optical filter material such as Cu-phthalogreen is not required for the resin as a rear surface packing material 35.

The lead wires 24 are firmly fixed into the rear surface packing material 35 and drawn to the bottom surface of the protection case. Hence, the resin molding layer 25 is not required to protect the lead wires at the bottom of the case, unlike the conventional detecting element as shown in FIG. 3. Thus, the lead wires according to the present invention have advantages of having a comprehensively slimmer thickness and further simplifying the manufacturing process.

In general, the protection case is of a cylindrical shape. However, other diverse shapes such as rectangular or tube shapes are also available. If the surface of a human body or a target, to which the detecting element will be attached, is curved, the rear surface of the protection case may be of a curved shape to comply therewith.

FIG. 26 is a schematic diagram illustrating an internal structure of a simulated magazine 200 according to the present invention. Referring to FIG. 26, the mechanical structure outside of a line 40 comprises a shooting mode designation switch 202 and input/output devices 201, 205. The internal structure blocked by the line 40 includes diverse electric modules such as 203 and 204.

The simulated magazine 200 according to the present invention is a housing composed of a hardened plastic material to have an identical or similar shape to a real magazine. Installed inside of the simulated magazine 200 are electric modules for processing percussion signals and converting the same into shooting signals, instead of an ammunition cartridge or spring for loading bullets like the real magazine, a PCB, a power supply (not shown in the drawing). A shooting mode designation switch necessary for generating a shooting signal is mounted on an external surface thereof. An upper section 208 thereof is structured to be inserted into a magazine insertion section of a gun like a real magazine.

To be specific, percussion signal input means 201 is formed on a side surface of the simulated magazine to receive a percussion signal outputted from the percussion signal output means 103. It is as described above that the percussion signal input means 201 communicates with the percussion signal output means 103 in wired or wireless manner.

A microcomputer 204 is installed inside of the simulated magazine to receive a percussion signal from the percussion signal output means, recognize a shooting mode preset by the shooting mode designation switch 202 upon receipt of the same from a shooting mode module section 203, and generate a corresponding shooting signal.

The microcomputer 204 includes a memory device to be used for main memory and storage of simple data as well as the modules necessary for microcomputers in general such as register, counter, calculator, etc. The microcomputer 204 may comprise a non-volatile memory such as flash memory or FeRAM.

The reason for housing the shooting mode designation switch 202 and the shooting mode module section 203 in the simulated magazine according to the present invention lies in enhancing the training effect of the soldiers by exactly simulating the shooting mode of the real small arms. The transmitter used in the conventional MILES adopted a manner of loading blank bullets in the real magazine. Hence, it needs neither a simulated magazine comprising an electronic circuit nor a separate shooting mode designation switch, unlike the present invention. However, the present invention, which has been conceived not to consume blank bullets, requires a substitutable device.

The shooting mode designation switch 202 may be identical or similar to the shooting mode designation switch in real firearms that is operated by rotating a protruded handle around a shaft. The shooting mode module section 203 designates the number of shooting based on a set shooting mode, and notifies the same to the microcomputer. Hereinafter, the shooting mode designation switch 202 and the shooting mode module section 203 will be inclusively referred to as the shooting mode designation means.

For reference, the shooting modes include an automatic mode for quick firing of consecutively shooting all the bullets loaded in the magazine with a single triggering, a semi-automatic mode for single firing, and a locked mode for preventing undesired shooting. In the real firearms, the operation of breechblock or gas tube, etc. is mechanically controlled. The difference in the present invention lies in setting the operation as a program logic computable by the microcomputer.

Another reason for requiring the shooting mode designation switch in the present invention is because the period of time for pulling a trigger of a gun differs depending on each soldier's triggering habit. If the percussion signal generated by pulling a trigger exactly becomes a percussion signal of a transmitter, the laser light will be consecutively shot in proportion to the period of time for pulling a trigger. This situation is the same as simulating a machine gun because the laser light will be consecutively shot as long as the trigger is pulled, but is different from actually shooting small arms used for individual firearms such as M16 or K2. To avoid such circumstances, the percussion signal generated by a single triggering is used merely as a signal of notifying the microcomputer of a necessity to generate a shooting signal irrespective of the duration of generating the percussion signals. The firing in the laser light transmitter is determined by the shooting signal generated from the microcomputer upon setup of the shooting mode. A series of pulsar laser lights are consecutively shot as many as determined in accordance with the MILES code predetermined by a single shooting signal.

### Other Modes for Carrying out the Invention

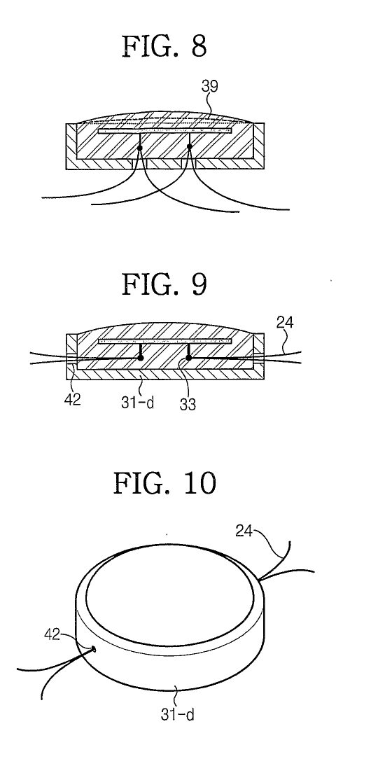

FIG. 8 is a cross-sectional view of the detecting element according to another mode of the present invention. Referring to FIG. 8, the detecting element includes a protection shield, in which a conductive mesh 39 is widely spread and solidified. The mesh consists of twisted slim wires composed of electro-conductive metals, etc. The tips of the mesh are connected to the ground wire, etc. to shield the electromagnetic interference (EMI) and to enhance mechanical strength of the protection shield.

FIG. 9 is a cross-sectional view of the detecting element according to another mode of the present invention, and FIG. 10 is a perspective view of FIG. 10. Throughout the entire description, same drawing reference numerals are used for the same elements even in different drawings unless expressed otherwise.

Referring to FIGS. 9 and 10, the lead wires are drawn not from the bottom or rear surface but from the side surface of the protection case 31-d through lead wire holes 42 of a tunnel shape penetrated in horizontal direction. This mode is to reduce the phenomenon that the lead wires are twisted or broken due to friction with the soldier's clothes or a surface of the harness on the rear surface of the detecting element.

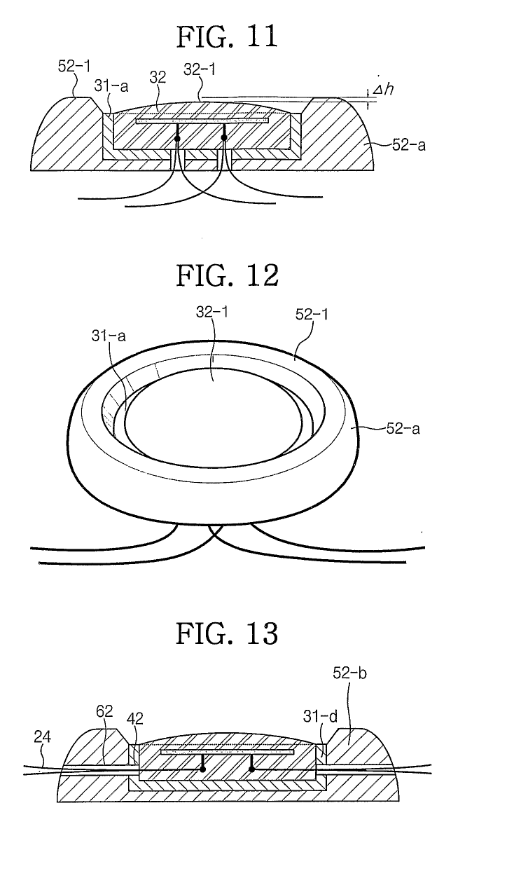

FIG. 11 is a cross-sectional view of the detecting element according to another mode of the present invention, and FIG. 12 is a perspective view of FIG. 11. Referring to FIGS. 11 and 12, the detecting element further comprises a protrusion protection section 52-a having a front surface 52-1 further protruded forward than the most protruded portion 32-1 of the protection case 31-a to form a difference Δh between steps by surrounding a periphery of the protection case 31-a on the external surface thereof.

The protrusion protection section 52-a is to protect the relatively vulnerable protection shield 32 and the optical detector cell inside thereof. In case where a front surface of the detecting element is crashed with a solid and plane ground, for example, the front surface 52-1 of the protrusion protection section 52-a is crashed with the ground earlier than the protruded portion 32-1 of the protection shield so as to prevent the protection shield to be broken or damaged by absorbing the impact. Therefore, the protrusion protection section is preferably composed of metal or hardened resin, etc., which is solid but not easily broken.

Other various shapes of protrusion protection section are also available in addition to the ones shown in the drawings. For example, the protrusion protection section may be protruded toward a part of the periphery of the protection case 31-a rather than surrounding the entire periphery. Also, impact absorption efficiency can be enhanced by additionally coating the thin rubber film on the front surface 52-1 of the protection case 31-a.

FIG. 13 is a cross-sectional view of the detecting element according to another mode of the present invention. Similar to the mode in FIG. 9, lead wire holes 42, 62 are formed in the shape of tunnel penetrating the protection case 31-d and all the side surfaces of the adjacent protrusion protection section 52-b in horizontal direction so as to draw the lead wires outward. This mode comprising the protrusion protection section is also to prevent the lead wires from being twisted or broken on the rear surface of the detecting element, as in case of FIG. 9.

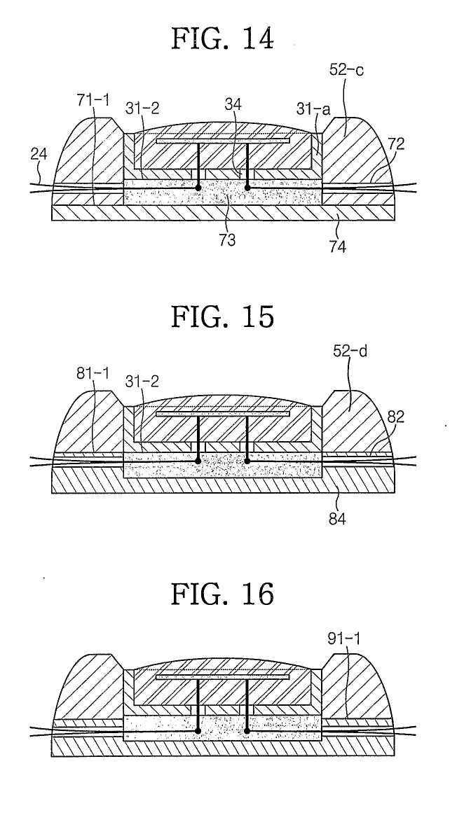

FIG. 14 is a cross-sectional view of the detecting element according to another mode of the present invention. The protrusion protection section 52-c is structured to have a front surface more protruded than the protection shield and a rear surface 71-1 further protruded backward than the rear surface 31-2. Lead wire holes 72 are formed in the shape of tunnel penetrating side surfaces of the protrusion protection section 52-c in horizontal direction so as to draw the lead wires 24 outward after passing through lead wire holes 34 formed on a rear surface of the protection case 31-a. A lower cover section 74 of a planar shape is mounted on the rear surface 71-1 of the protrusion protection section. A second packing material 73 is packed between the rear surface 31-2 of the protection case and the lower cover section 74 to seal and protect the set of lead wires 24.

The mode in FIG. 14 is to enhance production efficiency of the detecting elements. The protection case module including the optical detector cell is first manufactured, and mounted at the center of the inside of the protrusion protection section 52-c. The lead wires 24 are drawn through the lead wire hole 34, and the second packing material 73 such as resin is packed in the entire space formed on the rear surface 31-2. Thereafter, the lower cover section 74 is fixed onto the rear surface of the protrusion protection section by means of adhesive, screw or rivet. The time for hardening the packing material can be saved as a result. The second packing material 73 composed of a material that can pass the rear surface of the detecting element and absorb the impact thereon serves to further enhance the overall strength of the detecting element together with the packing material inside of the protection case.

The differences in the mode of FIG. 15 with that of FIG. 14 are that the rear surface of the protrusion protection section 52-d and an assembly boundary surface 81-1 of the lower cover section 84 are formed to have the same height as the rear surface 31-2 of the protection case, and that the lead wire hole 82 of the protrusion protection section is formed on a side surface of the lower cover section 84. FIG. 16 shows another available mode of assembly boundary surface 91-1.

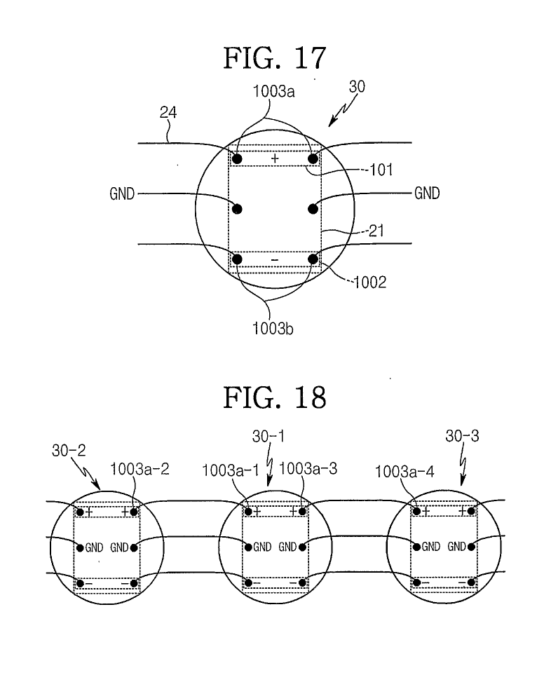

FIG. 17 is a schematic diagram illustrating a method of distributing lead wires according to the present invention. Referring to FIG. 17, an anode electrode 1001 and a cathode electrode 1002 of the optical detector cell 21 are located on both side surfaces thereof in the shape of bar so as to gather the electric signals generated from each optical detector module within the optical detector cell. The gathered electric signals flow into the lead wires 24 through two lead wire contact points 1003a, 1003b that are spaced according to the polarity, unlike in the conventional detecting element. Though FIG. 17 exemplifies the lead wires drawn out of the rear surface of the detecting element, the lead wires may be drawn out of the side surface of detecting element or of the protrusion protection section as described with reference to the preceding drawings.

FIG. 18 is a schematic diagram illustrating electric connections of a plurality of detecting elements 30-1, 30-2, 30-3 by using the distribution method in FIG. 17. FIG. 18 illustrates the detecting elements only for the sake of description. However, the protrusion protection section and the lower cover section may additionally be assembled therewith. Also, one skilled in the art would easily understand that the lead wires may also be electrically drawn in the same manner as in FIG. 18.

The respective detecting elements 30-1, 30-2, 30-3 are connected to an adjacent detecting element with the same polarity. To be specific, of the two anode electrode contact points 1003a-1 and 1003a-3 of the detecting element 30-1, the lead wire connected to the first anode electrode contact point 1003a-1 is connected to the anode electrode contact point 1003a-2 of the first detecting element 30-2 between the two detecting elements adjacent to the detecting element 30-1. The lead wire connected to the second anode electrode contact point 1003a-3 is connected to the anode electrode contact point 1003a-4 of the second detecting element 30-3 adjacent to the opposite side. The same manner is applied to the connection of cathode electrode.

The lead wire distribution method according to the present invention serves to prevent twist or noise of the lead wires that might be caused by connecting two lead wires to each terminal of the conventional detecting elements at once as shown in FIG. 3.

To eliminate static electricity and other electric noise that might be generated from all of the detecting elements, two spaced GNDs are formed at a detecting element, and ground wires linked thereto are connected to the GND of an adjacent detecting element so as to be ultimately connected to the ground attached to a soldier or a target.

Such ground wires are not the constitutional elements indispensable to the aforementioned set of lead wires but are added to merely further enhance the function of the device.

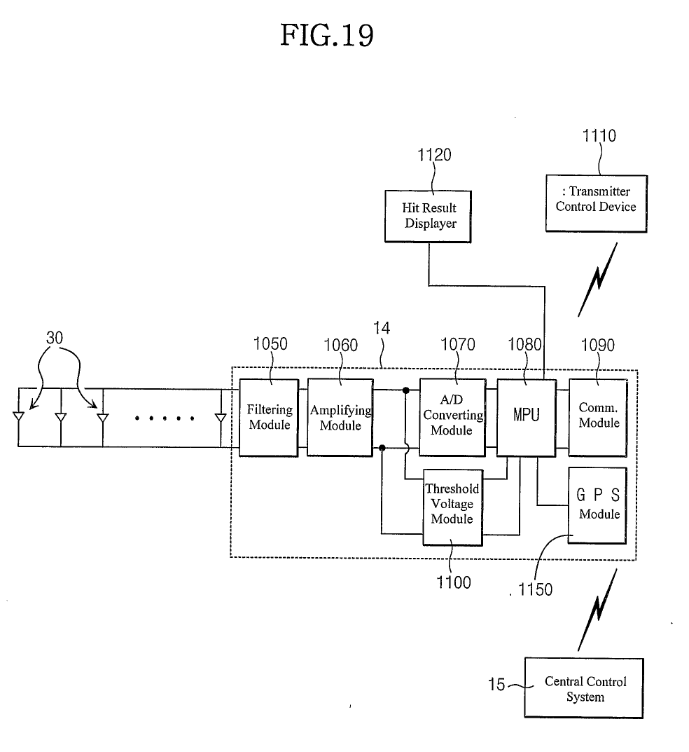

FIG. 19 is a block diagram of a detecting device according to the present invention. Each detecting element 30 connected in the aforementioned manner may be considered as a power source that is connected in parallel with each other. Such detecting element is connected to a module section 14 of a detecting device that will be provided for a central control system 15 or a control device 1110 of a transmitter.

The construction of the module section 14 of the detecting device will now be briefly described. The module section 14 comprises: a filtering module 1050 for filtering noise from the electric signals provided from the detecting elements except necessary electric signals; an amplifying module 1060 for amplifying the filtered electric signals; an A/D converting module 1070 for converting analog signals to digital signals; a detecting device MPU 1080 for automatically determining a hit based on the digitalized electric signals; a threshold voltage module 1100 for assisting in a more precise determination for hit by supplying an on/off signal to the detecting device MPU 1080 based on the threshold voltage to prevent the noise, which is the signals incapable of passing a predetermined threshold voltage among the amplified electric signals, from interrupting the determination for hit; and a communication module 1090 for transmitting the result of determination by the detecting device MPU 1080 to a central control system 15 and/or a control device 1110 of a transmitter, and receiving necessary control signals. In addition, a hit result displayer 1120 may be optionally connected to the module section 14 of the detecting device for notifying by means of sound and/or light that the target has been hit.

Of the above modules, the filtering module 1050, the amplifying module or the threshold module 1100 may be unnecessary if the electric signals from the detecting elements 30 are sufficiently great and have no noise. Also, the communication module 1090 may be mounted as a remote communication module having a large output for communication with a remotely located central control system 15, or as a close communication module for communication with a closely located transmitter control device 1110, or as an integrated single communication module to perform all kinds of communication. FIG. 19 exemplifies a case of employing an integrated communication module 1090.

Contrary to the manner of notifying the hit to the central control system 15, the central control system 15 may transmit the hit signal to the detecting device through the communication module 1090. Such incident may occur when designating a predetermined circumstance on a particular zone. For example, change of data values can substitute use of a simulated claymore or explosives when simulating a paralytic situation such as all of the soldiers within a particular zone are killed due to explosion of claymore, land mine, explosives or to aerial bombing, biochemical combat or nuclear bombing, etc., or all the targets of a particular zone are hit. In that case, all the soldiers or targets located in the corresponding zone are supposed to be hit. Therefore, the central control system 15 recognizes all the detecting devices located in the corresponding zone by means of a GPS module 1150, and transmits a hit signal to each communication module. Then, an MPU 1080 processes the signal and activates a hit result displayer 1120, and interrupts operation of the transmitter by transmitting a control signal to the transmitter control device 1110. In that case, the GPS module 1150 may be additionally included in the module section 14 of the detecting device.

The hit result displayer 1120, which is necessary to immediately interrupt the hostile acts of the hit soldiers or vehicles, is constructed to enable the soldiers to clearly recognize the hit through sound and/or screen by means of warning light, speaker, PDA or LCD, etc. that may be attached to each soldier or vehicle on an independent basis. Upon receipt of the hit signal from the communication module 1090, the transmitter control device 1110 immediately controls the corresponding transmitter not to shoot any more light. Thus, the above two devices allow the soldiers to immediately recognize the hit and to be deviated from the battlefield so as not to continue the hostile acts even if the deviation is not by mistake or in bad will.

The transmitter control device 1110 receives an original ID signal, which has been assigned to the detecting device MPU 1080 at the initial reset stage, from the detecting device MPU 1080 and memorizes the same so as to be additionally included in the existing MILES code when shooting pulsar laser light of a MILES code. As a consequence, the central control system can recognize and record which detecting device or transmitter hit the target with the pulsar laser light. Using such manner enables the transmitter to generate the original ID signal of the detecting device mounted by the subject of control of itself. For example, the transmitter can even simulate a case of combating with a third party's arms abandoned in the battlefield.

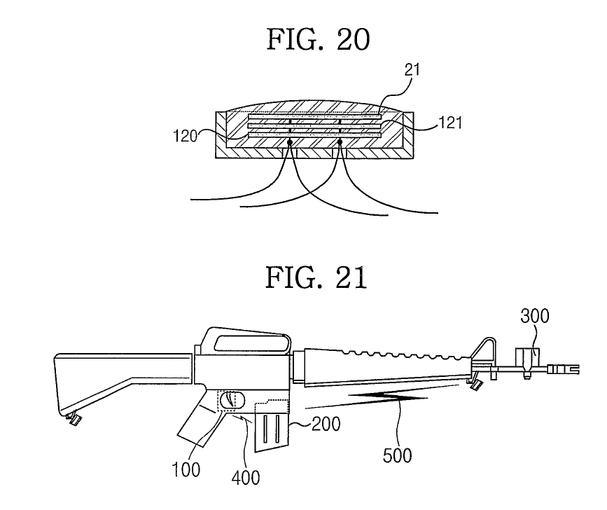

FIG. 20 is a cross-sectional view of the detecting element according to another mode of the present invention. In addition to the optical detector cell 21 for receiving light and generating electric signals, the detecting element further comprises a signal amplifying chip 120 for amplifying the electric signals generated from the optical detector cell once again, and/or a detecting element ID generation chip 121 for generating an electric signal originally assigned to the corresponding detecting element only. The signal amplifying chip 120 amplifies the electric signal generated from the optical detector cell 21 as many times as predetermined, and supplies the same to the detecting device module section 14. An MOS-FET chip controlling a gate by means of the electric signal of the optical detector cell may be used, for example. The signal amplifying chip 120 does not necessitate the filtering module 105, amplifying module 106 or the threshold module 110 in the detecting device module section because the signals generated therefrom have much greater values than the simple noise. As a result, the detecting device module section can be more simplified.

Furthermore, the total value of the electric signals amplified as many times as the number of hit detecting elements will be converted to digital signals so as to be supplied to the detecting device MPU 108. Therefore, the degree of injury of the hit soldiers or targets can be well simulated. To be specific, in the another mode without the signal amplifying chip 120, the electric signals generated from each detecting element are totaled and amplified again to simply determine the hit. In case of additionally comprising the signal amplifying chip 120, however, the amplifying degree can be controlled to the extent of differentiating the signal levels between the case when a single detecting element has been hit and the case when n number of detecting elements have been hit, for instance. Thus, the MPU, which has measured the levels of electric signals provided by the detecting elements, can grasp the exact number of the hit detecting elements in accordance with a predetermined logic, and transmit a signal representing the number of hit detecting elements to the central control system so as to more really simulate the concepts of full-destruction, half-destruction, death or injury, etc. that are used in simulated training.

If hit, the detecting element ID generation chip 121 detects generation of an electric signal from the optical detector cell, and generates the original ID signal value of the corresponding detecting element so as to be supplied to the detecting device module section. The detecting device MPU 108 then recognizes this value and determines which detecting element attached to a particular portion has been hit. Thereafter, the MPU transmits to the central control system the signal representing which detecting element attached to a particular portion has been hit. The central control system then can simulate the injured or damaged portion of each soldier or target. Also, if any one of the detecting elements malfunctions, the ID generation chip can immediately detect the malfunctioning one. Thus, repair can be easily performed.

It is out of question that either one of the signal amplifying chip 120 or the detecting element ID generation chip 121 can be optionally used.

The gun simulation system according to the present invention as shown in FIG. 21 is mounted on real firearms such as M16, M60, K1, K2 or K3, etc. The gun simulation system comprises a percussion signal generation section 100 for generating a percussion signal based on movement of a trigger, a simulated magazine 200 for generating a shooting signal by processing the percussion signal 400, and a laser light transmitter 300 for generating laser pulsar wave including a MILES code based on the shooting signal 500 outputted from the simulated magazine 200. These three sections are connected to one another by wire or wirelessly.

Hereinafter, the signal generated from the percussion signal generation section 100 located at the trigger will be referred to as the percussion signal 400, while the percussion signal converted to a signal to control the laser light transmitter 300 by the simulated magazine 200 will be referred to as the shooting signal 500.

The percussion signal generation section 100 comprises a percussion signal generation device for generating a percussion signal, which is an electric signal, by the force of pulling the trigger, and a percussion signal output device for transmitting the percussion signal to the simulated magazine.

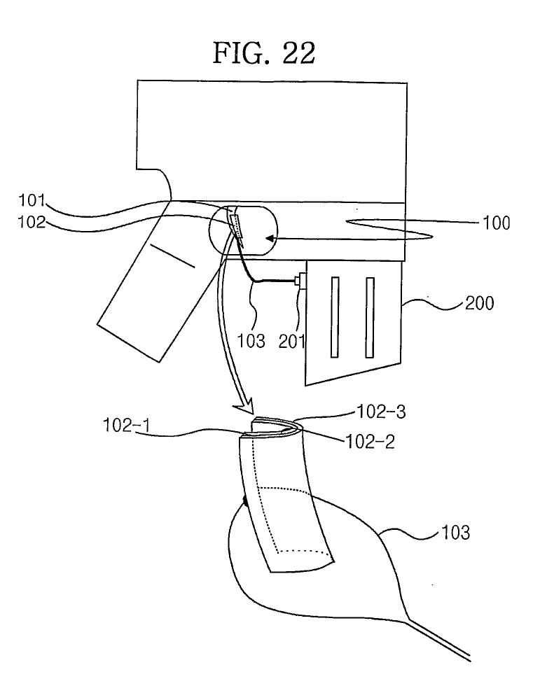

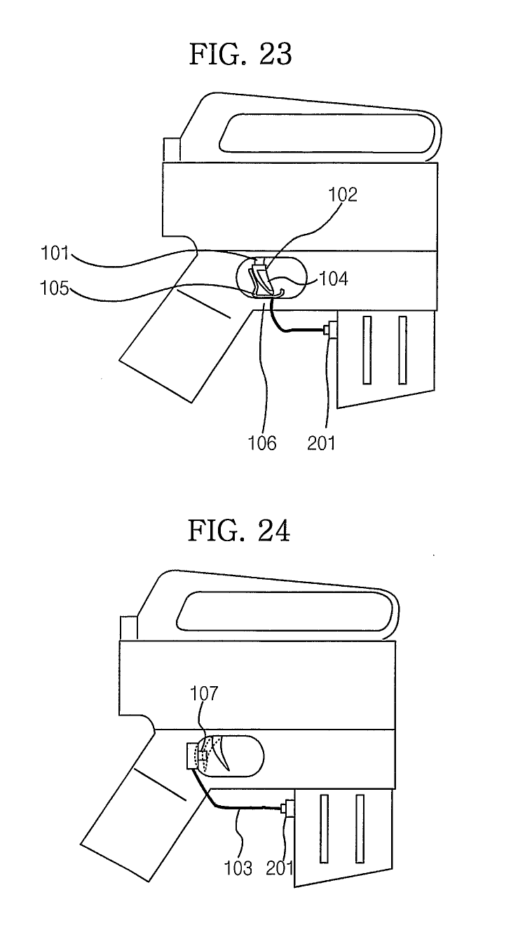

FIGS. 22 and 23 illustrate percussion signal generation devices according to different modes of the present invention. The percussion signal generation device in FIG. 22 is constructed to generate electric current due to the force of pulling the trigger by attaching a piezoelectric element 102 of a thin shape to a front surface of the trigger 101, with which a finger is in contact. The electric current generated as a percussion signal for shooting by pushing the piezoelectric element 102 is transmitted to an input port 201, which is a percussion signal input device of the simulated magazine for receiving the percussion signal, through a set of lead wires, which is a percussion signal output device 103.

The piezoelectric element utilizes dipole, which is generated when crystalline structure is reorganized inside of a material such as crystal, tourmaline, or piezoelectric ceramics, etc. upon receipt of compressive force or extensive force. Macroscopically, the piezoelectric element refers to an element generating electric current at two opposite poles of a piezoelectric material while changing its thickness or shape. Detailed description of the piezoelectric element will be omitted here as it is well know to those skilled in the art.

The piezoelectric element 102 is a percussion signal generation device according to the present invention. The piezoelectric element 102 comprising a piezoelectric material 102-1 sandwiched between two electrodes 102-2 and 102-3 in a planar shape can be folded by surrounding a part of the front surface of the trigger, and can be attached to a trigger by means of magnet or two-sided adhesive tape (not shown in the drawings.)

The electric current generated by pulling a trigger may be used as a percussion signal per se or by undergoing a process of amplifying or converting the electric current into a wave signal.

FIG. 23 is a schematic diagram of a percussion signal generation device of a wire type according to another mode of the present invention. The percussion signal generation device in FIG. 23 further comprises supporting means 104 of a band or thimble shape (hereinafter, referred to as the “band shape”) for supporting the piezoelectric element 102 by surrounding a periphery of the trigger 101 and being tightly attached to the inner surface of the trigger 101 so as not to be detached. The percussion generation device may additionally comprise skid-proof means 105 such as leather belt, etc. on a side surface of the supporting means of a band shape to prevent skidding of the supporting means 104 from the trigger 101 because of a vertical resistance force generated due to weight of the lower portion thereof on a protection frame 106.

FIG. 24 is a schematic diagram of a percussion signal generation device of a wire type according to another mode of the present invention. Referring to FIG. 24, a switching element 107 is attached to a rear surface of the trigger 101. When the trigger 101 is pulled, the rear surface therefore pushes the switching element 107 to generate a percussion signal. The switching element 107 may be attached to a protection frame on the rear surface of the trigger 101 be means of magnet or two-sided adhesive tape, as shown in FIG. 24, or to the rear surface of the trigger 101 on the opposites side of the protection frame so that the protection frame can push the switching element 107.

Here, the percussion signal output device refers to all means for transmitting the percussion signal generated from the percussion signal generation device to the simulated magazine 200 housing a microcomputer. Wire type lead wires 103, which connect the percussion signal generation devices 102, 104, 107 to the percussion signal input device 201 of the simulated magazine 200, may be used as a percussion signal output device to transmit electric signals in a wire type as shown in FIGS. 22 to 24. It is also possible to transmit the percussion signal through wireless communication.

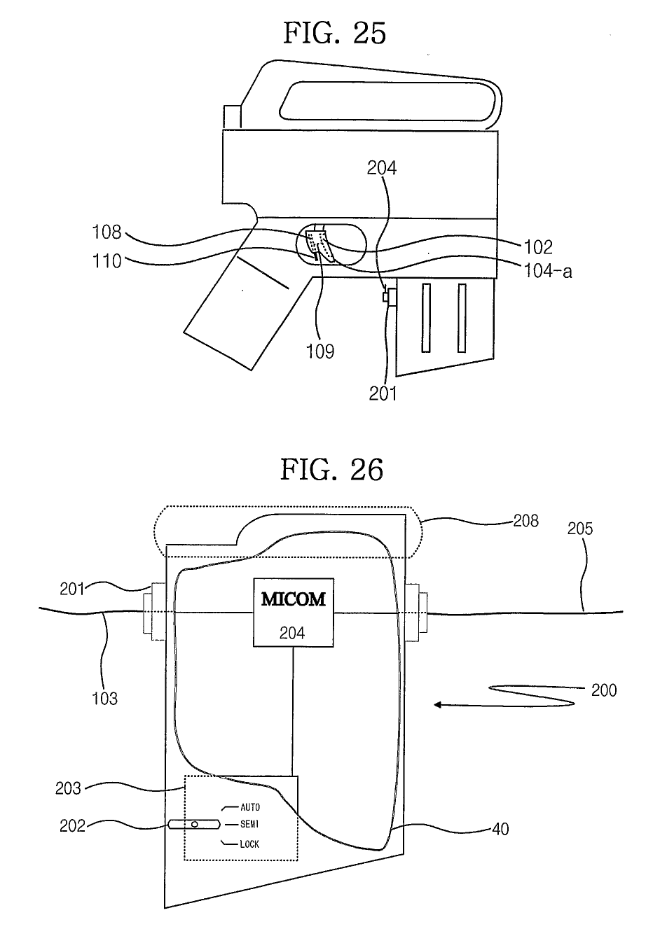

FIG. 25 is a schematic diagram of a percussion signal generation device of a wireless type according to another mode of the present invention. In the percussion signal generation device in FIG. 25, an RF signal generation chip 108 is mounted inside of supporting means 104-a of a band type as means for converting a percussion signal to a wireless signal and connected to the piezoelectric element 102 through a cable 109. An electric signal, which is a percussion signal generated by pushing the piezoelectric element 102, is transmitted to the RF signal generation chip 108 through the cable 109 and converted to a wireless signal so as to be wirelessly transmitted to an antenna 202 of a percussion signal input device 201 of the simulated magazine through an antenna 110.

FIG. 25 exemplifies a percussion signal generation device, in which the piezoelectric element 102 is combined with the supporting means 104-a of a band type. However, it is out of question that wireless communication can also be performed by mounting the RF signal generation chip on the rear surface of the switching element when using the switching element as shown in FIG. 24.

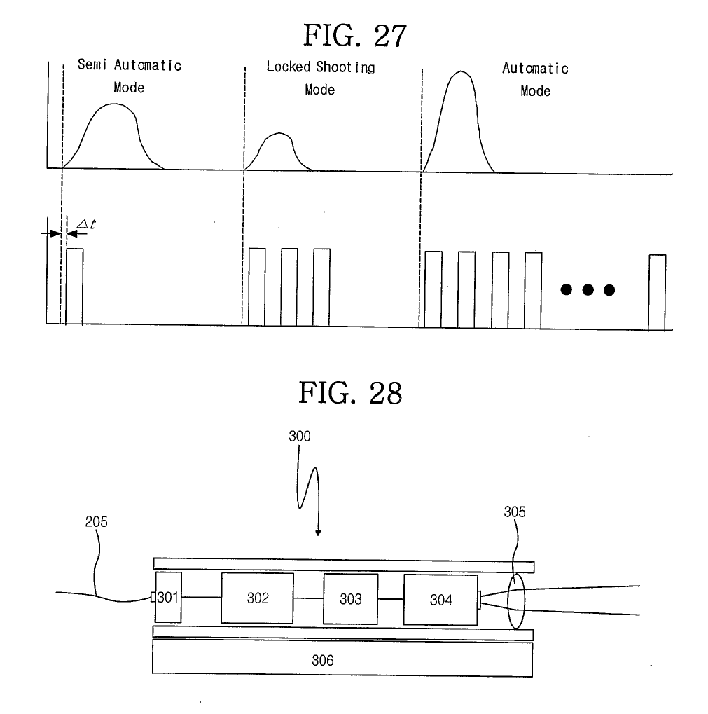

The upper drawing in FIG. 27 is a graph illustrating percussion signals generated by pulling a trigger. The lower drawing in FIG. 27 is a graph illustrating shooting signals generated by a microcomputer according to the shooting modes with respect to each percussion signal. Here, the axis x represents time, while the axis y represents intensity of the signal.

The percussion signal may be generated with different duration of time and intensity depending on individuals and circumstances. While receiving and processing the percussion signals, however, the microcomputer generates as many as shooting signals according to the shooting modes: a single shooting signal in case of a semi-automatic mode; 3 shooting signals in case of 3-mark shooting as used in K2, etc.; and as many as the number of remaining real bullets computed in the magazine in case of an automatic mode. A slight time difference Δt may occur between generation of a percussion signal and of a shooting signal as long as required for input and computation. However, such a time difference is relatively shorter than the time required for explosion of real explosives, and does not affect simulation of the performance at all. The number of remaining real bullets is computed by subtracting the accumulated number of generated shooting signals from the predetermined total number of real bullets in the magazine by means of a counter, etc.

The generated shooting signal is transmitted to the transmitter control device through a shooting signal output section 205. Here, the manner of outputting the shooting signal may be either of a wire or wireless type.

FIG. 28 is a schematic diagram illustrating a structure of a laser light transmitter 300 according to the present invention. The transmitters are generally attached to a gun barrel, but may be attached to the main body, etc. of a gun unless interrupting the laser light.

The shooting signal transmitted through the shooting signal output section 205 is supplied to the MPU 302 of the transmitter through a shooting signal input section 301. The MPU 302 of the transmitter stores a MILES code comprises pulsar wave of 16 or 32 bit, and controls on/off of the switching element 303 so as to shoot the laser light representing the MILES code with respect to each shooting signal. The switching element 303 generates a pulsar wave by switching on/off a laser diode 304 according to the supplied pulsar signal. The generated laser light is shot toward a target through a lens 305 for controlling an angle of emitting the laser light. A battery 306 is housed in the transmitter 300 to supply energy to each module.

When the transmitter 300 communicates with the simulated magazine in wireless manner to transmit the shooting signal, the shooting signal output section 205 comprises a wireless signal generation chip and an antenna annexed thereto. It is out of question that the shooting signal input section may also comprise an antenna and a module for receiving the wireless signal.

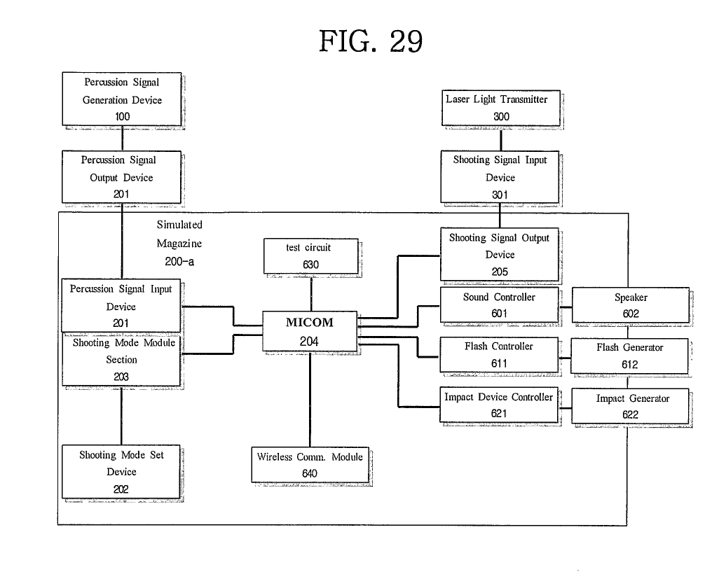

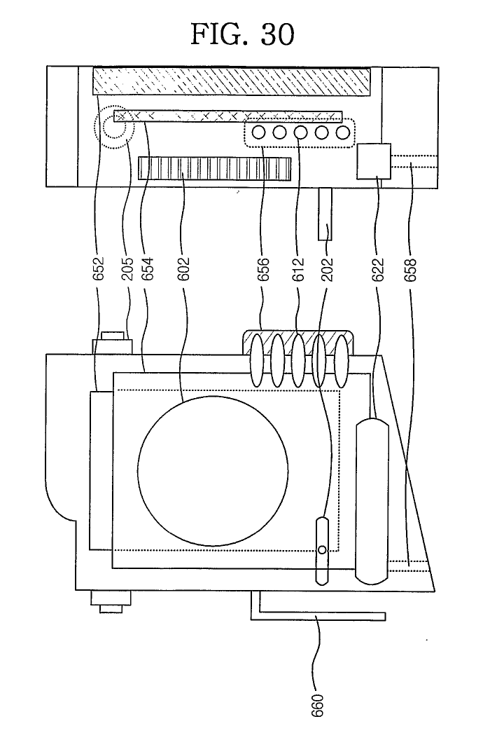

FIGS. 29 and 30 are diagrams illustrating a simulated magazine according to the modes of the present invention. FIG. 29 is a block diagram illustrating electric modules, and FIG. 30 is a schematic diagram illustrating a corresponding mechanical structure.

A simulated magazine 200-a in FIG. 29 further comprises a speaker 602 for generating sound, a flash generator 612 and/or an impact generator 622 in addition to the constitutional elements of the preceding modes so as to generate sound, flash or impact when shooting a laser light to be similar to that generated when shooting real bullets. This is to enhance the training effect by enabling the soldiers participating in the training to have a real sense.

Referring to FIG. 29, it is as described above that the microcomputer 204 receiving a percussion signal from the percussion signal input device 201 confirms a shooting mode, which has been set by the user by means of the shooting mode set device 202, from the shooting mode module section 203 and generates a shooting signal corresponding thereto so as to transmit the same to the transmitter 300 through the shooting signal output device 205. Before or after generation of the shooting signal, the microcomputer 204 controls the speaker 602, the flash generator 612 and/or the impact generator 622 by means of the sound controller 601, the flash controller 611 and/or the impact device controller 621 that are respectively connected thereto so as to create similar effects in terms of sound, flash and/or impact.

FIG. 30 is a schematic diagram illustrating a mechanical structure of FIG. 29. The drawing on the left side shows a side surface of the simulated magazine 200-a, and the drawing on the right side is a front view of the internal and external structures of the simulated magazine 200-a. In the two drawings, same drawing reference numerals are used for the same parts or modules, while the modules attached to outside of the simulated magazine are particularly identified by the drawing reference numerals 202, 204, 612, 656 and in the shape of protrusion.

The speaker 602, which is a sound generator, is aligned on a side surface of the simulated magazine. This speaker is to provide the shooter and the neighboring zone with a shooting sound by reproducing the explosive sound that has been recorded in the microcomputer in advance. To be specific, the fundamental objective of mounting the speaker 602 is to enable the soldiers participating in the training to have a real sense of shooting real bullets as well as to detect the enemy by means of a sound.

The speaker 602 can additionally perform a function of radio installations for receiving instructions or status reports from a training control system, a training regulator or a commander in the battlefield. This is to maximize the efficiency of handling the equipment by substituting the simulated magazine for a wireless communication system. In order to substitute the function for walkie-talkie or wireless installations, a wireless communication module 640 is additionally required. In FIG. 30 for example, the wireless communication module 640 is mounted inside of the PCB board 654 in the form of a chip, and antenna means 660 is mounted outside thereof for performing wireless communication.

To better spread the sound, the speaker 602 may additionally comprise a plurality of small holes formed on the surface of the magazine adjacent thereto in the manner of partially exposing the speaker.

A flash generator 612 comprising LED, etc. is mounted on a lower portion of the front surface of the magazine to simulate the flash, which is generated from the muzzle of a gun when shooting a real bullet, by generating a momentary and strong light like the flash from camera toward a front direction of the gun when shooting a laser light. The flash generator is also mounted for the same objective as the speaker 602 so as to enable the participants of the training to detect location of an enemy upon recognition of a shooting flash from a remote distance with a real sense.

The flash generator 612 may comprise one or more luminous elements, and in particular, a plurality of white LEDs of high luminance. The flash controller 611 allows instant discharge of electric charge accumulated in a capacitor of large capacity, which is mounted on the PCB board 654, toward the flash generator 612. A protection shield 656 composed of transparent resin, etc. may additionally be mounted on the flash generator 612 to protect the surface thereof from impact, etc.

The impact generator 622, which is a device of generating impact sensed by a shooter through firearms, is to simulate fluttering of the aiming due to an impact generated at the time of shooting in addition to providing a real sense. As a specific example, the impact generator 622 may comprise a cartridge of a cylindrical shape including compressed gas. In that case, the compressed gas can be sprayed before or after generation of the shooting signal through a nozzle 658 exposed from the magazine by opening a solenoid valve (not shown in the drawing), which is controlled by the impact device controller 621.

Another available method is to construct the impact generator 622 with a piezoelectric element of large capacity and generate vibration by flowing electric current into the piezoelectric element before or after generation of the shooting signal.

The simulated magazine in FIG. 30 further comprises the battery 652 for supplying the power to the aforementioned microcomputer 204, each module and the PCB board 654 embodying necessary electric distribution as well as to each device. The simulated magazine may additionally comprise a test circuit 630 to easily test and repair the devices. The test circuit 630 determines whether or not each module is normally operated at the time of resetting the device. If any abnormality is found, the test 630 notifies the user of the abnormal status by means of a speaker with a pre-recorded sound so that the related equipment can be easily repaired before starting the training.

In addition to the sound communication as described above, the antenna means 660 and the wireless communication module 640 interlocked therewith may also be used as a percussion signal input device for receiving a percussion signal from the percussion signal output device 103, or as a shooting signal output device for wirelessly outputting the shooting signal to the shooting signal input device 301, respectively. In that case, the modules 201, 205 performing reception and transmission of the percussion signal or the shooting signal in FIG. 29 may not be included on a separate basis.

The antenna means 660 may be housed inside of the magazine in the form of a thin film or of a loop rather than of an external protrusion unlike shown in the drawing according to the layout. Further, the simulated magazine per se may also perform the function of antenna without the antenna means.

It is out of question that the speaker, the impact generator and the flash generator described above may be embodied on a separate basis or on a simultaneous basis by integrating more than one of them.

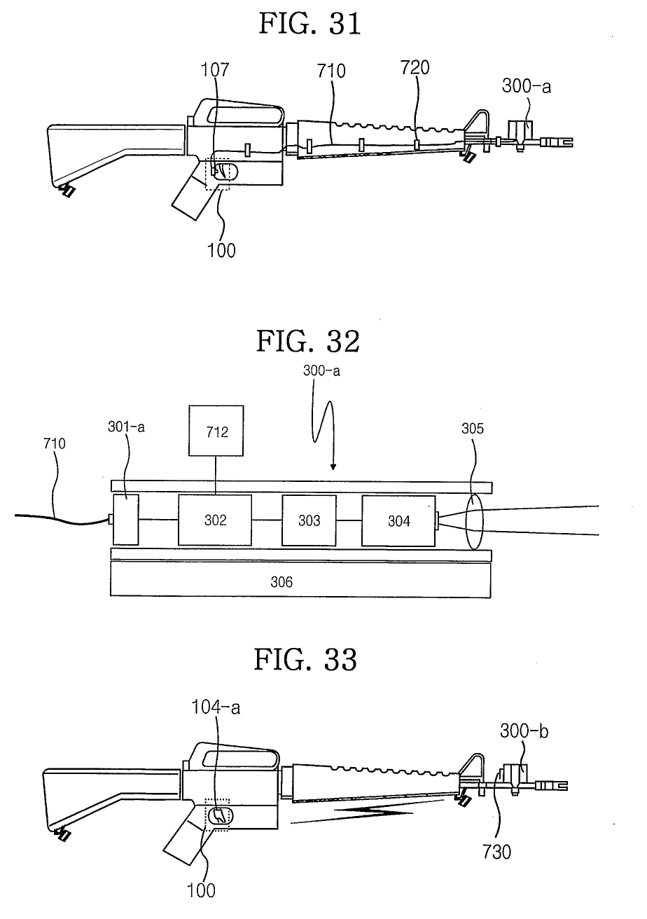

FIGS. 31 and 32 illustrate another mode of carrying out the present invention.

Referring to FIG. 31, the percussion signal generation device 100 generates a percussion signal by means of the switching element 107 identical or similar to the one shown in FIG. 24. The percussion signal is transmitted to the laser light transmitter 300-a by means of a set of lead wires 710, which is a percussion signal output device. The laser light transmitter 300-a shoots a pulsar laser light including the MILES code in accordance with the percussion signal.

The most distinctive feature of the mode in FIG. 31 lies in that the percussion signal generated from the percussion signal generation device 100 is directly transmitted to the laser light transmitter 300-a without a simulated magazine, etc. for converting the percussion signal to a shooting signal so that a laser light can be shot. To realize such operation, the percussion signal inputted to the percussion signal input device 301-a should be converted to a digital signal through the lead wires 710 and transmitted to the transmitter MPU 302. The transmitter MPU 302 should recognize this percussion signal as a shooting signal and drive the switching element 303 so that a pulsar laser light can be shot by the laser diode 304.

The mode described above exemplifies a case of shooting only a single light with a single percussion signal. However, it is also possible to mount a shooting mode set section 712 on the laser light transmitter to additionally set the number of laser lights to be shot with a single percussion signal according to an automatic shooting mode or a semi-automatic shooting mode.

FIG. 31 shows an additional construction of lead wire adhering means 720 to tightly adhere the lead wires 710 to a gun. The lead wire adhering means 720 may be diversified such as scotch tape, a magnet or a finger stop.

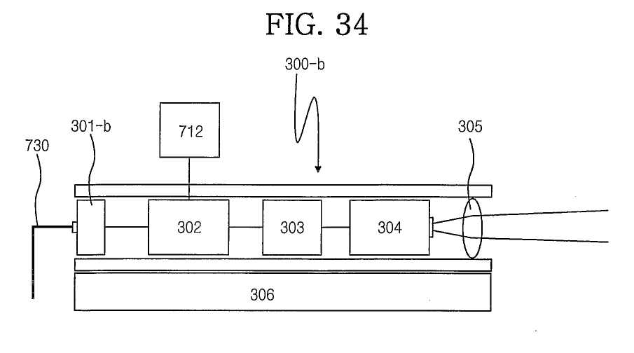

FIG. 33 shows another mode for carrying out the present invention. The mode in FIG. 33 shares the same aspect as in FIG. 31 in the construction of using the percussion signal as a shooting signal of a laser light transmitter 300-b without a simulated magazine. Without a simulated magazine, however, the mode in FIG. 33 is further characterized in that the percussion signal is wirelessly transmitted to the laser light transmitter. As a percussion signal generation device 100, a device identical or similar to the supporting means 104-a of a band shape in FIG. 25 housing an RF signal generation chip, etc. is used. FIG. 34 exemplifies construction of a laser light transmitter 300-b operated by a wireless signal. However, the percussion signal wirelessly transmitted to the antenna 730 is converted to a percussion signal, which is a digital signal, by a shooting signal input device 301-b so as to be processed by the transmitter MPU 302, the switching element 303 and the diode 304, etc. The shooting mode set section 712 may also be additionally constructed.

The modes in FIGS. 31 to 34 exemplify a switching element or supporting means of a band shape as a percussion signal generation device. However, it is out of question that any kind of percussion signal generation device of a wire or wireless type may be used to perform the same function.

### INDUSTRIAL APPLICABILITY

The present invention relates to a detecting device in a MILES and a gun simulation system.

The detecting device according to the present invention is thinner than the conventional one but has improved intensity and sensitivity. Therefore, the detecting device according to the present invention provides a good sense of wearing and is not easily destroyed. With enhanced accuracy in determination for hit, the detecting device according to the present invention can be utilized in the field of military training or in survival games, etc. for general citizens.

The simulated magazine in the gun simulation system according to the present invention is a safer and cost-effective electronic system compared with the conventional one using dangerous gunpowder. Being capable of demonstrating a variety of simulated situations, the simulated magazine in the gun simulation system according to the present invention can also be utilized in the field of military training or in survival games, etc. for general citizens.

While the invention has been shown and described with reference to certain best modes to carry out the invention, it will be understood by those skilled in the art that various changes in form and details may be made therein without departing from the spirit and scope of the invention as defined by the appended claims.

1. A detecting element of a MILES for determining a hit by detecting a light shot from a light transmitter, the element comprising:
an optical detector cell of a planar shape for generating an electric signal when detecting a light;
a protection case of a cylindrical shape for supporting the optical detector cell housed inside thereof;
a set of lead wires, each of which being electrically connected to an anode electrode and a cathode electrode of the optical detector cell for transmitting the electric signal generated from the optical detector cell to hit determination means; and
a protection shield located on a front light detecting surface of the optical detector cell for protection of the same from external environment and shielding noise light, wherein
the protection case of a cylindrical shape has an open front surface,
the optical detector cell of a planar shape is located to be adjacent to the open front surface of the protection case, and the rear surface of which is supported by a packing material packed inside of the protection case, and
the set of lead wires is elongated from the rear surface of the optical detector cell and protected by the packing material.

2. The detecting element of claim 1, further comprising conductive mesh located on a front light detecting surface of the optical detector cell for passing the light and filtering an electronic wave.

3. The detecting element of claim 1, wherein the protection case is attachable and detachable.

4. The detecting element of claim 1, wherein the protection shield and the packing material are chemically combined into a single unit for surrounding and supporting the optical detector cell.

5. The detecting element of claim 1, wherein the set of lead wires are drawn outside of the protection case by being connected to two anode contact points and two cathode contact points, respectively,
the lead wires connected to a first anode electrode contact point of the two anode electrode contact points are connected to an anode electrode contact point of the first detecting element of the two detecting elements, which are adjacent to both sides of the detecting element, and the lead wires connected to a second anode electrode contact point is connected to an anode electrode contact point of the second detecting element of the two adjacent detecting elements, and
the lead wires connected to a second cathode electrode contact point of the two cathode electrode contact points are connected to a cathode electrode contact point of the first detecting element, and the lead wires connected to a second electrode contact point are connected to a cathode electrode contact point of the second detecting element.

6. The detecting element of claim 5, wherein the set of lead wires further comprises ground wires connected to two spaced GNDs of the optical detector cell, one of which is connected to a ground wire of the first detecting element, and the other of which is connected to a ground wire of the second detecting element.

7. The detecting element of claim 1, further comprising lead wire holes of a tunnel shape penetrating side surfaces of the protection case in horizontal direction so as to draw the set of lead wires outward.

8. The detecting element of claim 1, further comprising a protrusion protection section having a front surface further protruded forward of a front surface of the protection case than the protection shield while surrounding a periphery thereof.

9. The detecting element of claim 8, further comprising lead wire holes of a tunnel shape penetrating all the side surfaces of the protection case and the adjacent protrusion protection section in horizontal direction so as to draw the set of lead wires outward.

10. The detecting element of claim 1, further comprising:
a protrusion protection section formed to have a front surface further protruded than the protection shield toward the direction of a front surface of the protection case while surrounding a periphery of the protection case, and a rear surface further protruded than the protection case toward the direction of a rear surface of the protection case, and lead wire holes of a tunnel shape penetrating side surfaces thereof in horizontal direction; and
a lower cover section of a planar shape, a periphery of which is engaged with the rear surface of the protrusion protection section for sealing of the rear surface of the protection case, wherein
the set of lead wires is drawn outward from the rear surface of the protection case through the lead wire holes, and
a second packing material is packed between the rear surface of the protection case and the lower cover section to seal and protect the set of lead wires.

11. The detecting element of claim 1, further comprising:
a protrusion protection section formed to have a front surface further protruded than the protection shield toward the direction of a front surface of the protection case while surrounding a periphery of the protection case; and
a lower cover section of a planar shape, a periphery of which is engaged with the rear surface of the protrusion protection section for sealing of the rear surface of the protection case, wherein
the side surfaces of the protruded periphery of the lower cover section include lead wire holes of a tunnel shape penetrated in horizontal direction,
the set of lead wires are drawn outward from the rear surface of the protection case through the lead wire holes, and
a second packing material is packed between the rear surface of the protection case and the lower cover section to seal and protect the set of lead wires.

12. The detecting element of claim 1, further comprising detecting element ID generation means for generating an electric signal to represent an original ID of the detecting element.

13. The detecting element of claim 1, further comprising signal amplifying means for amplifying the electric signal generated from the optical detector cell.

14. The detecting element of claim 1, wherein the hit determination means is at least more than one of the microprocessor connected to the detecting element by means of wire communication or the central control system connected to the detecting element by means of wireless communication.

15. A detecting device of a MILES for determining a hit by detecting a light shot from a light transmitter, the device including a plurality of detecting elements electrically connected to one another, each of which comprising:
an optical detector cell of a planar shape for generating an electric signal when detecting a light; a protection case of a cylindrical shape for supporting the optical detector cell housed inside thereof; a set of lead wires connected to an anode electrode and a cathode electrode of the optical detector cell, respectively, for transmitting the electric signal generated from the optical detector cell; and a protection shield located on a front light detecting surface of the optical detector cell for protecting the same and shielding noise light,
the protection case of the cylindrical shape having an open front surface, the optical detector cell of a planar shape being located to be adjacent to the open front surface of the protection case and the rear surface of which being supported by a packing material packed inside of the protection case, and the set of lead wires being drawn outward through lead wire holes formed to penetrate the protection case,
the plurality of detecting elements being connected to one another in parallel by the set of lead wires, the tips of which including a microprocessor (MPU) for determining a hit after receiving the electric signal generated from the optical detector cell from the set of lead wires.

16. The detecting device of claim 15, wherein one of the detecting elements further comprises a protrusion protection section further protruded forward of a front surface of the protection case than the protection shield while surrounding a periphery thereof.

17. The detecting device of claim 15, further comprising a lower cover section of a planar shape, a periphery of which being engaged with a rear surface of the protrusion protection section for sealing a rear surface of the protection case.

18. The detecting device of claim 17, wherein the side surfaces of the protruded periphery of the lower cover section include a second lead wire hole of a tunnel shape penetrated in horizontal direction, and the set of lead wires are drawn outward from the protection case through the second lead wire hole, and
a second packing material is packed between the rear surface of the protection case and the lower cover section to seal and protect the set of lead wires.

19. The detecting device of claim 15, wherein the set of lead wires are drawn to the rear surface of the protection case by being respectively connected to two anode electrode contact points and two cathode electrode contact points that are spaciously mounted on the optical detector cell of the detecting device so as to connect the plurality of detecting elements in parallel, wherein
the lead wire connected to the first anode electrode contact point of the two anode electrode contact points is connected to the anode electrode contact point of the first detecting element between the two detecting elements adjacent to both sides of the detecting element, and the lead wire connected to the second anode electrode contact point is connected to the anode electrode contact point of the second detecting element adjacent to the opposite side,
the lead wire connected to the first cathode electrode contact point of the two cathode electrode contact points is connected to the cathode electrode contact point of the first detecting element between the two detecting elements adjacent to both sides of the detecting element, and the lead wire connected to the second cathode electrode contact point is connected to the cathode electrode contact point of the second detecting element adjacent to the opposite side.

20. The detecting device of claim 19, wherein the set of lead wires further comprises a ground connected to two spaced GNDs of the optical detector cell, wherein the first ground is connected to the ground of the first detecting element, and the second ground is connected to the ground of the second detecting element.

21. The detecting device of claim 15, further comprising a communication module for supplying a signal generated from the microprocessor to the transmitter.

22. The detecting device of claim 21, wherein the signal generated from the microprocessor is at least more than one of the ID signal representing an ID of the detecting device or a transmitter control signal for interrupting operation of the transmitter upon determination of a hit of the detecting device.

23. The detecting device of claim 15, further comprising a communication module for supplying the signal generated from the microprocessor to a remotely located central control system.

24. The detecting device of claim 23, wherein each detecting element further comprises detecting element ID generation means for generating an original ID signal and supplying the same to the microprocessor when generating the electric signal, and the microprocessor supplies the information as to which detecting element has been hit to the central control system based on the received original ID signal.

25. The detecting device of claim 23, wherein each detecting element further comprises signal amplifying means for amplifying the electric signal generated from the optical detector cell, and the microprocessor supplies the information as to how many detecting elements have been hit to the central control system by measuring the amplified electric signal values.

26. The detecting device of claim 23, further comprising a GPS module for indicating location of the detecting device.

27. The detecting device of claim 15, wherein the plurality of detecting elements may be spaciously mounted on chest, belly, back or head portions of a soldier.

28. The detecting device of claim 15, wherein the plurality of detecting elements may be spaciously mounted on a surface of a weapon used in at least one of the land, sea or air.

29. A gun simulation system comprising:
percussion signal generation means for generating a percussion signal when a trigger of a gun is pulled;
percussion signal output means for outputting the generated percussion signal;
a housing of a magazine, an upper tip of which is inserted and fixed into a magazine insertion section of the gun; and
a laser light transmitter attached to the gun for shooting a laser light toward a target, wherein the housing includes
percussion signal input means for receiving the percussion signal outputted from the percussion signal output means,
shooting mode designation means for designating a shooting mode of the laser light transmitter,
a microcomputer for generating a responsive shooting signal upon recognition of a shooting mode designated by the shooting mode designation means after receiving the percussion signal from the percussion signal input means, and
shooting signal output means for supplying the shooting signal generated from the microcomputer to the laser light transmitter,
the laser light transmitter having shooting signal input means for receiving the shooting signal outputted from the shooting signal output means and shooting a laser light based on the inputted shooting signal, whereby a simulation is performed as if the target has been hit when the shot laser light is incident to the detecting element mounted on the target.

30. The gun simulation system of claim 29, wherein the percussion signal generation means includes a piezoelectric element attached to a front surface of the trigger for generating a percussion signal by changing the shape thereof due to a force of pulling the trigger.

31. The gun simulation system of claim 29, wherein the percussion signal generation means includes a switching element attached to a rear surface of the trigger for generating a percussion signal by being pushed due to a force of pulling the trigger.

32. The gun simulation system of claim 29, wherein the percussion signal output means supplies the percussion signal to the percussion signal input means in either one of the wired or wireless manner.

33. The gun simulation system of claim 29, wherein the shooting mode controls the number of shooting of the laser light to correspond at least to any one of automatic, semi-automatic or locked mode of the gun with respect to a single percussion signal.

34. The gun simulation system of claim 29, wherein the shooting signal output means supplies the shooting signal to the shooting signal input means in either one of wired or wireless manner.

35. The gun simulation system of claim 29, wherein the laser light is a consecutive pulsar wave complying with the MILES code rules.

36. The gun simulation system of claim 30, wherein the percussion signal generation means further comprises supporting means of a band shape for supporting the piezoelectric element by surrounding a periphery of the trigger.

37. The gun simulation system of claim 36, wherein the percussion signal generation means further comprises skid-proof means located between the supporting means and a trigger protection frame for supporting the supporting means so as not to skid from the trigger.

38. The gun simulation system of claim 29, wherein the housing further comprises a speaker for generating a necessary sound through control by the microcomputer.

39. The gun simulation system of claim 38, wherein the sound includes at least more than one of a simulated shooting sound of the gun, a control command, or a report notifying abnormal operation of the simulation system.

40. The gun simulation system of claim 29, wherein the housing further comprises a flash generator for simulating a shooting flash of the gun.

41. The gun simulation system of claim 40, wherein the flash generator includes a luminous element mounted on an external front surface of the housing.

42. The gun simulation system of claim 29, wherein the housing further comprises an impact generator for simulating a shooting impact of the gun.

43. The gun simulation system of claim 42, wherein the impact generator is at least either one of a piezoelectric element or a compressed gas discharger that can be vibrated by the electric signal.

44. The gun simulation system of claim 29, wherein the housing further comprises a wireless communication module for performing wireless communication.

45. A simulated magazine of a magazine shape used in a gun simulation system, including an upper tip inserted and fixed into a magazine insertion section of a gun, for shooting a laser light from a laser light transmitter attached to a gun barrel by pulling a trigger of a gun and simulating a hit of a target bearing a detecting element, the simulated magazine comprising:
percussion signal input means for receiving a percussion signal generated by pulling of a trigger of the gun;
shooting mode designation means for designating a shooting mode of the laser light transmitter;
a microcomputer for generating a responsive shooting signal upon recognition of a shooting mode designated by the shooting mode designation means after receiving the percussion signal from the percussion signal input means; and
shooting signal output means for supplying the shooting signal generated from the microcomputer to the laser light transmitter.

46. The simulated magazine of claim 45, further comprising a speaker for generating a necessary sound through control by the microcomputer.

47. The simulated magazine of claim 46, wherein the sound includes at least more than one of a simulated shooting sound of the gun, a control command, or a report notifying abnormal operation of the simulation system.

48. The simulated magazine of claim 45, further comprising a flash generator for simulating a shooting flash of the gun.

49. The simulated magazine of claim 48, wherein the flash generator includes a luminous element mounted on an external front surface of the housing.

50. The simulated magazine of claim 45, further comprising an impact generator for simulating a shooting impact of the gun.

51. The simulated magazine of claim 50, wherein the impact generator is at least one of a piezoelectric element or a compressed gas discharger that can be vibrated by an electric signal.

52. The simulated magazine of claim 45, further comprising a wireless communication module for performing wireless communication.

53. The simulated magazine of claim 46, further comprising circuit test means for checking abnormal operation of each means, and notifying abnormality by means of the speaker, if found.

54. A gun simulation system comprising:
percussion signal generation means for generating a percussion signal when a trigger of a gun is pulled;
percussion signal output means for outputting the generated percussion signal;
a housing of a magazine inserted and fixed into a magazine insertion section of the gun to have any one shape of a magazine, a cartridge or a bomb shell; and
a laser light transmitter attached to the gun for shooting a laser light toward a target, the housing including
percussion signal input means for receiving the percussion signal outputted from the percussion signal output means,
shooting mode designation means for designating a shooting mode of the laser light transmitter,
a microcomputer for generating a responsive shooting signal upon recognition of a shooting mode designated by the shooting mode designation means after receiving the percussion signal from the percussion signal input means, and
shooting signal output means for supplying the shooting signal generated from the microcomputer to the laser light transmitter,
the laser light transmitter having shooting signal input means for receiving the shooting signal outputted from the shooting signal output means and shooting a laser light based on the inputted shooting signal, whereby a simulation is performed as if the target has been hit when the shot laser light is incident to the detecting element mounted on the target.

55. A gun simulation system comprising:
percussion signal generation means for generating a percussion signal when a trigger of a gun is pulled;
percussion signal output means for outputting the generated percussion signal;
a housing of a magazine inserted and fixed into a magazine insertion section of the gun to have any one shape of a magazine, a cartridge or a bomb shell; and
a laser light transmitter attached to the gun for shooting a laser light toward a target,
the percussion signal output means being a cable lead wire electrically connected to the laser light transmitter for transmitting the percussion signal to the laser light transmitter, wherein
the laser light transmitter receives and converts the percussion signal to a digital signal so as to shoot a laser light based on the converted signal and simulate that a target has been hit if the shot laser light is incident to a detecting element mounted on the target.

56. A gun simulation system, comprising:
percussion signal generation means for generating a percussion signal when a trigger of a gun is pulled;
percussion signal output means for outputting the generated percussion signal;
a housing of a magazine inserted and fixed into a magazine insertion section of the gun to have any one shape of a magazine, a cartridge or a bomb shell; and
a laser light transmitter attached to the gun for shooting a laser light toward a target, wherein
the percussion signal output means generates a wireless percussion signal to be wirelessly transmitted to the laser light transmitter,
the laser light transmitter receives and converts the wireless percussion signal to a digital signal so as to shoot a laser light based on the converted signal and simulate that a target has been hit if the shot laser light is incident to a detecting element mounted on the target.
